(19) United States
(12) Patent Application Publication
(10) Pub. No.: US 2022/0400302 A1
(43) Pub. Date: Dec. 15, 2022

(54) DISPLAY CONTROL FOR TELEVISIONS

(71) Applicant: InVue Security Products Inc., Charlotte, NC (US)

(72) Inventors: Kyle Baker, Waxhaw, NC (US); Anthony J. Rocheford, Victoria, MN (US); Christopher J. Fawcett, Charlotte, NC (US)

(21) Appl. No.: 17/772,916

(22) PCT Filed: Oct. 29, 2020
(86) PCT No.: PCT/US2020/057958

§ 371 Date: Apr. 28, 2022

Related U.S. Application Data
(60) Provisional application No. 62/929,492, filed on Nov. 1, 2019.

(51) Int. Cl. H04N 21/258

(52) U.S. Cl. CPC H04N 21/25875

(57) ABSTRACT

Systems and methods for controlling displays of televisions are provided. In one example, a display control system includes a plurality of televisions and a plurality of TV sensors. Each TV sensor is operably engaged with a respective one of the plurality of televisions. The display control system further includes a control device located remotely from the plurality of televisions and the plurality of TV sensors and configured to communicate with each of the plurality of TV sensors. The control device is configured to transmit a control signal to each of the plurality of TV sensors for controlling the televisions.

### CROSS REFERENCE TO RELATED APPLICATIONS

This application claims the benefit of priority to U.S. Provisional Application No. 62/929,492 filed on Nov. 1, 2019, the entire disclosure of which is incorporated herein by reference.

### BACKGROUND OF THE INVENTION

Many types of establishments, including retail stores, restaurants, hotels and airports, utilize television (“TV”) displays. For retailers, these TVs are on display for people to look at to help inform a purchase decision. For restaurants, customers often watch TVs while dining. In other establishments, TVs can be used for other reasons such as informational displays. Regardless of the use, many establishments wish to turn the TVs off during certain hours such as when the establishment is closed. This can be a problem, especially in establishments with a large number of TVs. The TVs might all use different remote controls, making it time consuming to turn them all off. The remote controls must be managed, stored, batteries replaced and kept in a way to ensure they do not get lost. When lost, a new remote must be purchased. Often, TVs are mounted in places that cannot be reached by a human without a ladder. In these situations, if a remote is lost, it becomes very inconvenient to turn the TV on and off or switch channels. Moreover, it is difficult for retailers to know what TVs are displayed and functioning properly without auditing each of the TVs.

### BRIEF SUMMARY

Embodiments of the present invention are directed towards TV sensors, systems, and methods for communicating with and/or controlling televisions. In one example, a display control system includes a plurality of televisions and a plurality of TV sensors. Each TV sensor is configured to operably engage with a respective one of the plurality of televisions. The display control system further includes a control device located remotely from the plurality of televisions and the plurality of TV sensors and configured to communicate with each of the plurality of TV sensors. The control device is configured to transmit a control signal to each of the plurality of TV sensors for controlling the televisions.

In another embodiment, a TV sensor includes a housing, an HDMI connector operably engaged with the housing and configured to facilitate communication with an HDMI input port of a television, and wireless communication circuitry contained in the housing for communicating with a control device located remotely from the television. The wireless communication circuitry is configured to receive a control signal from the control device, wherein the HDMI connector is configured to communicate with the television for controlling the television based on the control signal.

In another embodiment, a method for controlling a plurality of televisions is provided. The method includes operably engaging a plurality of TV sensors with a respective one of a plurality of televisions and inputting a command at a control device located remotely from the plurality of televisions and the plurality of TV sensors such that a control signal is transmitted to each of the plurality of TV sensors for controlling the televisions.

### BRIEF DESCRIPTION OF THE DRAWINGS

FIG. 1 is schematic of a display control system according to one embodiment of the present invention.

FIG. 2 is a schematic of a TV sensor in operable engagement with a television according to one embodiment.

FIG. 3 is a perspective view of a TV sensor according to one embodiment of the present invention.

FIG. 4 is a perspective view of the TV sensor of FIG. 3 showing an HDMI cable connector operably engaged with HDMI connector of the TV sensor.

FIG. 5 is a schematic of a display control system according to one embodiment of the present invention.

FIG. 6 is a perspective view of a TV sensor according to one embodiment of the present invention.

FIG. 7 is an end view of the TV sensor of FIG. 6.

FIG. 8 is an opposite end view of the TV sensor shown in FIG. 7.

### DETAILED DESCRIPTION OF EMBODIMENTS OF THE INVENTION

Referring to the accompanying figures wherein identical reference numerals denote the same elements throughout the various views, the embodiments of methods and systems disclosed herein are capable of controlling a plurality of TVs without the need for a remote control. Although described in relation for use in a retail environment or store, the system 10 shown and described herein is suitable for other settings, such as for example, a residential or commercial environment, and is not intended to be limited to use only as a system for a retail environment.

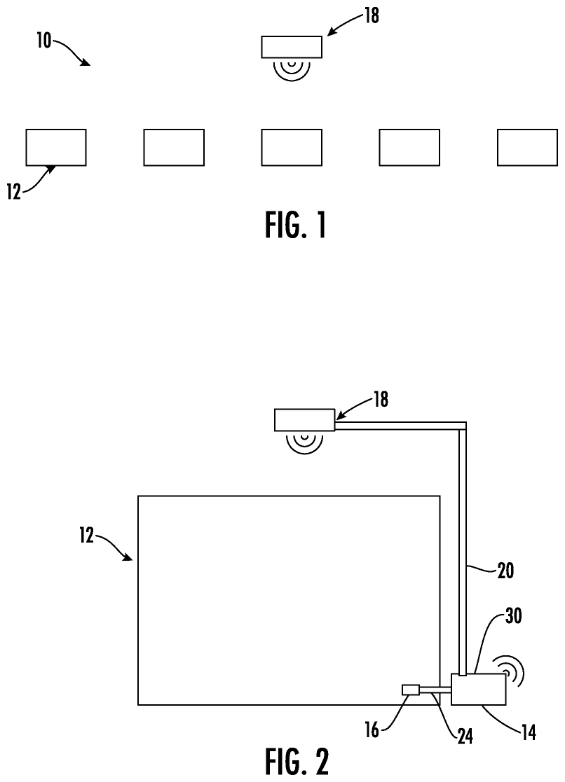

As TVs have added more and more features, they have gained the ability to be controlled by other devices than the remote control. One means of control is a protocol called HDMI-CEC (Consumer Electronics Control) in which signals are delivered via a HDMI connector to control a TV. Some of these controls are power on, power off, tuner control, playback control, among others. According to one embodiment, a system 10 is provided that includes a plurality of TVs 12 and a plurality of TV sensors 14 (see, e.g., FIGS. 1-2). As shown in FIG. 1, the TVs are separate and independent from one another and configured to be independently controlled.

A control device 18 may be used for communicating with any one of the TVs 12 or all of the TVs via an associated TV sensor 14. For example, the control device 18 may be configured to send messages to a number of TVs 12 simultaneously (e.g., in real time or near real time) or control each of them independently from a remote location. The control device 18 may be independent of and located remotely from the TVs. For instance, the control device 18 may located in a back office of a retail store or other establishment, or the control device may be at a location that is remotely located from the retail store or other establishment where the TVs are located. In other cases, the control device 18 may be located within a retail store or establishment, but remotely from the TVs 12. For instance, the control device 18 may be a sales associate's mobile device (e.g., phone or tablet) that is configured to communicate with each of the TV sensors 14 located within a particular retail store. Thus, the control device 18 is “remote” or located “remotely” from the TV sensors 14 in that they do not need to be in proximity with one another or in physical engagement with one another in order to communicate with one another. Moreover, the control device 18 may be configured to communicate remotely from the TV sensors 14 from any desired location.

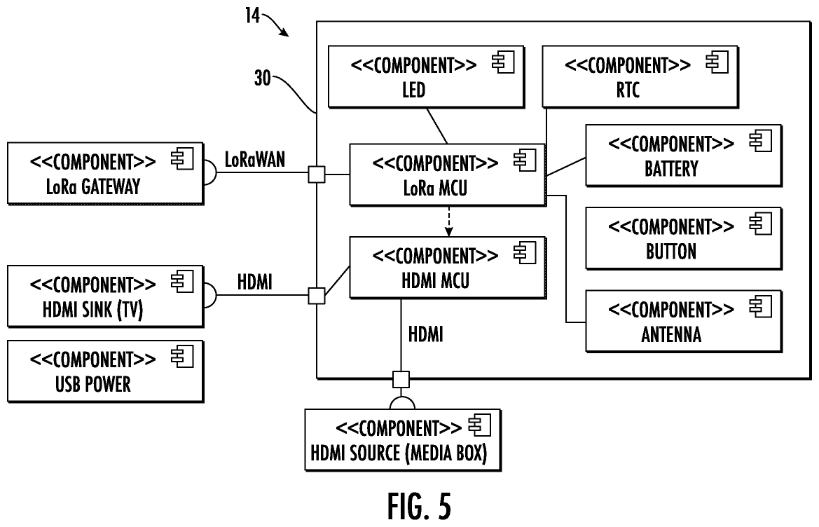

In some embodiments, the control device may be part of a network of devices, for example, including a gateway or aggregator (see, e.g., FIG. 5, LoRa gateway), that is configured to send and receive signals over a cloud network. According to some example embodiments, the control device 18 may be a computer that is configured to communicate with a plurality of TVs. In some embodiments, a plurality of control devices may be used, such as a combination of a computer, mobile devices, and/or gateway that are configured to communicate directly to the TV sensors 14 or with one another. In other examples, the control device 18 may be a gateway device that is configured to communicate or relay control signals to the TV sensors 14. The control device 18 may be configured to transmit one or more signals to each of the TV sensors 14. For instance, the control device 18 may be configured to broadcast a single signal that is detected by each of the TV sensors 14. In other cases, the control device 18 may transmit individual control signal to each TV sensor 14 or transmit control signals to a grouping of selected TV sensors.

In one embodiment, a TV sensor 14 is employed that provides the ability to control a plurality of TVs 12 by connecting to the HDMI input ports 16 using CEC communication. CEC communication may be effectuated using wired or wireless means or a combination thereof.

In one embodiment, one or more TV sensors 14 may be wired to a control device 18 using HDMI cables 20 (see, e.g., FIG. 2). Where a plurality of TVs 12 are desired to be controlled, the HDMI cables 20 can be aggregated into a single control device 18. In one embodiment, the control device 18 may be connected to one or more additional computers and/or networks that has the ability to send commands to the control device. The control device 18 may be able to send global signals to each of the TVs 12 via communication with respective TV sensors (14 e.g., turning all TVs off) or individual signals to a given TV (e.g., activate input 3). In this manner, the control of the TVs 12 could occur at a single location such as a back office or at a remote location (e.g., via the internet). In some embodiments, the control device 18 may be set to automatically control one or more TVs 12. For example, the control device 18 may be automated from a corporate office according to a schedule in order to ensure local compliance with corporate plans (e.g., all TVs at a given location turn on at the same time, such as 8:00 AM). The control device 18 may send a control signal to the TV sensor 14 including the schedule. The schedule could be a daily, weekly, monthly, or customized schedule where certain actions are to be taken at predetermined times and days. In other embodiments, a schedule may be programmed in memory for each TV sensor 14 such that the TV sensor is able to communicate with a respective TV 12 without first receiving a command from a control device 18. For example, the TV sensor 14 may be configured to maintain the current time (e.g., using a real-time clock) and send a signal to a respective TV according the schedule stored in the TV sensor's memory. Furthermore, it is understood that the control device 18 may send a variety of control signals to the TV sensors 14, such as power on or off the TVs, change a channel of the TV, provide data to the TVs, provide images to be displayed at the TVs, etc.

In another embodiment, the TV sensors 14 and control device 18 may communicate wirelessly such that no cables are needed between the TVs and the control device. In this embodiment, the TV sensor 14 may include wireless communication circuitry along with CEC communication capability. The TV sensor 14 may have one or more additional connectors for operably engaging the TV 12, such as a connector for receiving power and charging a power source 28 (e.g., a USB connector). Many different forms of wireless communication protocols could be used, such as the LoRa or LoRaWAN standard, Bluetooth, WIFI, radiofrequency, etc. to communicate with the control device 18. In this manner, the TV sensor 14 is connected to the TV 12 via an HDMI connection, and there is no need to run or hide any cables, which may lead to increased ease of use and better aesthetics. Moreover, in this embodiment, CEC control signals are transmitted using the wireless communication circuitry over a network but have the ability to be controlled in a similar manner as the wired connections described above. In some cases, the TV sensor 14 may include an antenna for facilitating such wireless communication.

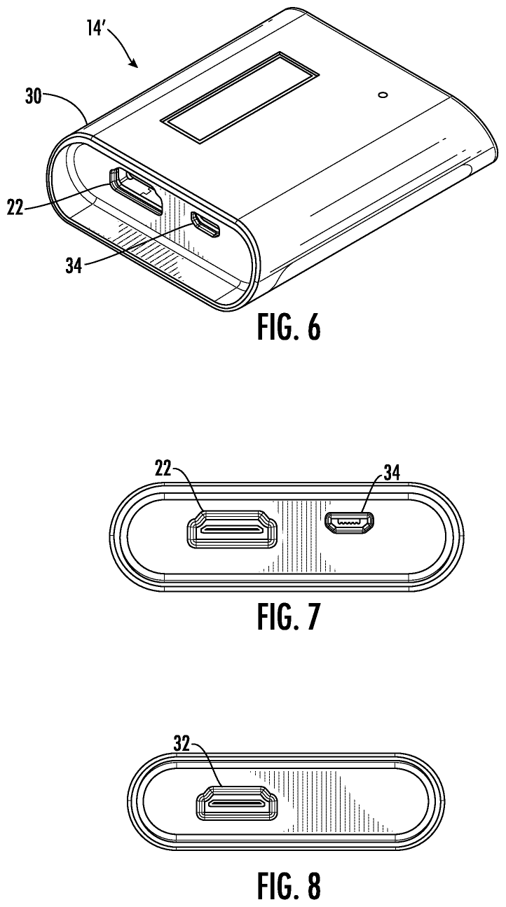

The TV sensor 14 may include a housing 30 that is configured to contain or operably engage various components, such as for example, a microcontroller or MCU(s), wireless communications circuitry (e.g., LoRa MCU), a memory, a real-time clock (“RTC”), HDMI input port(s), HDMI output port(s), power port(s), LEDs or indictors for status, antenna, buttons or like interfaces, and/or a power source (e.g., battery). FIGS. 6-8 show an embodiment of a TV sensor 14′ that shows a housing 30 containing an HDMI output connector 22, an HDMI input connector 32, and an input power port 34 for receiving power to charge the power source 28.

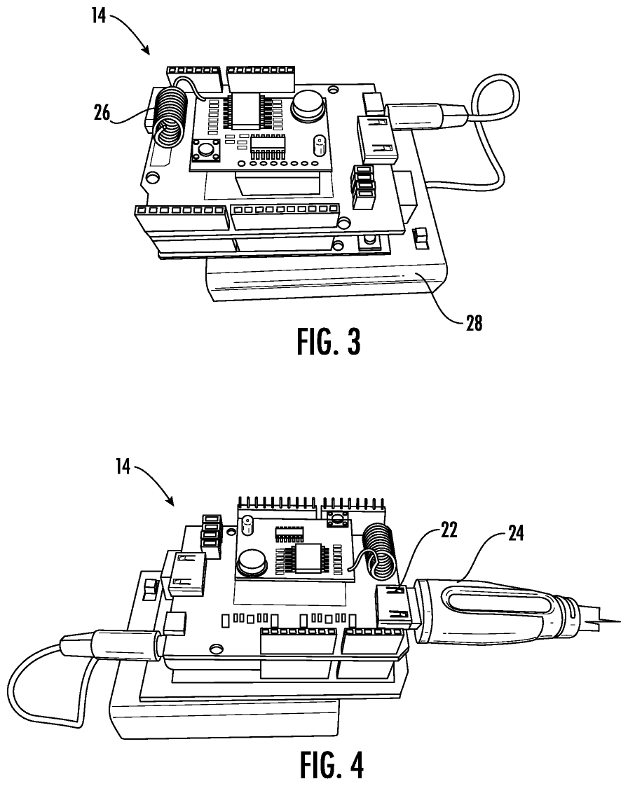

FIGS. 3-4 show one embodiment of a TV sensor 14 where the TV sensor includes an HDMI connector 22 for operably engaging the TV's HDMI input port 16 with an HDMI cable 24 having corresponding HDMI connectors on each end of the cable. The TV sensor 14 also includes wireless communications circuitry 26 for wirelessly communicating with the control device 18, which may include, for example, a wireless coil for communicating using the LoRa wireless protocol. In this example, the TV sensor 14 includes a power source 28, which may be external to the TV sensor 14 as shown in FIG. 3 or internal within the housing 30 of the TV sensor. As noted above, the TV sensor 14 may be configured to receive power from the TV 12, such as for charging the power source 28. The TV sensor 14 may be configured to operate using its power source 28 when the TV is in an off state. The TV sensor 14 may be configured to conserve its power in some cases, such as where the TV sensor includes wireless communication functionality and relies on the TV 12 for receiving its power. For instance, the TV sensor 14 may be configured to cease wireless communication based on the schedule of the TV 12, such as when the TV has been powered off. Thus, the TV sensor 14 may be configured to toggle between communicating wirelessly and ceasing wireless communication based on a schedule of the TV 12. In addition, the TV sensor 14 may be configured to transition to a sleep state to conserve power, but is configured to transition to a wake state upon receiving a command or signal from the control device 18.

In another embodiment, instead of the TV sensor 14 using the HDMI port, some other means of controlling the TVs 12 could be used. For example, an infrared (“IR”) transmitter could be used. The IR transmitter may be connected to the TV 12 in a way that covers or otherwise obstructs or disables the IR receiver for the TV. This transmitter could be wired or use wireless communication. In some cases, the control device 18 will be set up with the identification of the type of TV 12 that each IR receiver is connected to, but once this set up is completed, the control device could generate any appropriate remote-control signal and deliver it to the TV sensor 14 operably engaged with the TV. The TV sensor 14 may then be configured to control the IR transmitter to transmit an IR signal from IR transmitter to the TVs remote control input receiver. In some cases, the TV sensor 14 and IR transmitter may be integrated in a single unit such that the TV sensor may be configured to receive the control signals and communicate directly with the TVs remote control input receiver via IR to control the TV.

In another embodiment where a HDMI connection is not required, Bluetooth communication may be used to receive commands from the control device 18. In the case where TVs 12 are Bluetooth capable and use Bluetooth communication for their remote control devices, Bluetooth communication may be used to receive commands from the control device 18. In one example, a Bluetooth transmitter device could be attached anywhere on the TV 12. This transmitter may be configured to be paired to the TV 12 via Bluetooth communication. Again, this transmitter could be hardwired but may alternatively use a wireless signal to receive commands, and this transmitter may communicate with the TV sensor 14 or may be integrated therewith as a single component. In the instance where longer range communication is needed than is capable by Bluetooth communication, wireless communication (e.g., LoRa or WiFi communication) between the TV sensor 14 and the control device 18 could also be used. Thus, a combination of Bluetooth communication between the transmitter and the TV 12 and long range communication between the TV sensor 14 and the control device 18 may be used. Bluetooth may have interference issues with objects such as the human body or metal fixtures. Indeed, if one were within Bluetooth range of all the TVs, one would only need a single control device to connect to the Bluetooth radios of all the TVs to accomplish the goal of controlling the TVs. But, because Bluetooth has a limited communication range, this is often not practical. Therefore, by combining a long-range communication protocol with a Bluetooth device and operably engaging such device to each TV, the issues with range and interference should be reduced if not eliminated.

In each of the disclosed embodiments, the TV sensor 14 may be configured to obtain and communicate various types of information to the control device 18 or some other remote device (e.g., TV make, TV model, TV serial number, power status, TV location, etc.). For example, the TV sensor 14 could utilize CEC communication protocol to determine the make and/or model of the TV 12 it is connected to and communicate this information to the control device 18. Where HDMI is used, the Extended Display Digital Identification (“EDID”), Enhanced EDID (“E-EDID”), or DisplayID may be obtained from each of the TV sensors 14, which may be of the format prescribed by Video Electronics Standards Association (“VESA”) standards. The EDID may be determined using different methods, such as hot-plug detect (“HPD”) signal or 5V enable signal. These types of information may be beneficial, especially to retailers who have planograms to control what products are out on display. The TV sensor 14 may be configured to store the information in memory for communicating the information to the control device 18. The TV sensor 14 may be configured to obtain the information from the TV 12 and to deliver it to the control device 18 for monitoring. For example, a retailer may be able to track which TVs are powered on or off and what TVs are currently being displayed in a particular retail store, which avoids in-person audits. Thus, the information obtained from the TV sensors 14 may be used by retailers to monitor and manage planogram compliance and take appropriate remedial action based on feedback from the TV sensors.

In some embodiments, the TV sensor 14 may be configured to monitor if it is removed from the TV 12 and to send a message to the control device 18 or other remote device upon removal. The TV sensor 14 may be configured to detect this removal via the HDMI connection between the TV sensor and the TV 12. In some instances, removal of the TV sensor 14 may be detected using HPD, while in other cases a loss in communication with the TV sensor may be detected indicating a possible issue. The TV sensor 14 may be further configured to communicate the occurrence of the removal or other issue with the TV to the remote device 18. In this way, the corporate office or the store manager will know if a given TV 12 may be experiencing a problem, such as for example, the TV not turning on, the TV is missing, or the TV is not communicating or operating for some other reason.

In other embodiments, the system 10 could also deliver content to the TVs 12 via HDMI-CEC. For example, during low traffic hours, such as for example, the early morning of 24-hour stores, the control device 18 may issue a control signal for placing the TV 12 in a low power mode and/or turn on every few minutes to display various types of messages (e.g., “See Store Associate For Assistance”). The system 10 may also be configured to deliver images to the TVs 12 via the TV sensors 14.

In additional embodiments, the TV sensor 14 is configured to interface with a variety of media players or boxes, such as via HDMI input connector 32. For instance, the TV sensor 14 may utilize pass-through functionality to enable A/V data to be provided from the media player to the TV 12. In some cases, the TV sensor 14 may be located between the TV 12 and the media player such that the media box is able to communicate with the TV despite the presence of the TV sensor. The TV sensor 14 may include an HDMI input for interfacing with the media player and an HDMI output for interfacing with the TV 12.

According to additional embodiments, the system 10 may operate in conjunction with a network of wireless devices, such as those disclosed in U.S. Patent Provisional Application No. 62/909,506 filed on Oct. 2, 2019 and entitled Merchandise Display Security Systems and Methods, and International Patent Application No. PCT/US2020/031850 filed on May 7, 2020 and entitled Merchandise Display Security Systems and Methods, the entire disclosures of which are incorporated by reference herein, wherein in some embodiments, the TV sensor 14 and/or control device 18 may be configured to communicate within a wireless network with, or in a similar manner to, a plurality of merchandise security devices and electronic keys (e.g., in some embodiments, the TV sensors 14 and/or control device 18 may communicate in a network using the same wireless communications protocols as disclosed therein).

The foregoing has described one or more embodiments of systems and methods for display control for televisions. Although embodiments of the present invention have been shown and described, it will be apparent to those skilled in the art that various modifications thereto can be made without departing from the spirit and scope of the invention. Accordingly, the foregoing description is provided for the purpose of illustration only, and not for the purpose of limitation.

1. A display control system for a plurality of televisions comprising:
a plurality of televisions;
a plurality of TV sensors, each TV sensor configured to operably engage a respective one of the plurality of televisions; and
a control device located remotely from the plurality of televisions and the plurality of TV sensors and configured to communicate with each of the plurality of TV sensors, wherein the control device is configured to transmit a control signal to each of the plurality of TV sensors for controlling the televisions.

2. The display control system of claim 1, wherein each of the plurality of TV sensors is configured to wirelessly communicate with and receive control signals from the control device.

3. The display control system of claim 1, wherein each of the plurality of TV sensors is wired to the control device.

4. The display control system of claim 1, wherein each of the plurality of televisions comprises an HDMI input port, and wherein each of the plurality of TV sensors comprises an HDMI connector configured to operably engage a respective HDMI input port.

5. The display control system of claim 4, wherein each of the plurality of TV sensors is configured to communicate with a respective television using consumer electronics control (CEC) for controlling the television.

6. The display control system of claim 4, wherein each of the plurality of TV sensors is configured detect removal from a respective HDMI input port.

7. The display control system of claim 1, wherein each of the plurality of TV sensors is configured to wirelessly communicate with the control device using LoRa communication.

8. The display control system of claim 1, wherein the control signal comprises a schedule for automating the control of each of the TV sensors.

9. The display control system of claim 8, wherein each of the plurality of TV sensors is configured to store the schedule in a respective memory.

10. The display control system of claim 1, wherein each of the plurality of TV sensors is configured to obtain information from a respective television and to communicate the information to the control device.

11. The display control system of claim 10, wherein the information comprises extended display digital identification data for each of the plurality of televisions.

12. The display control system of claim 10, wherein the information comprises a make and model for each of the plurality of televisions.

13. The display control system of claim 1, wherein the control device is configured to send one or more images to each of the plurality of TV sensors for display on the plurality of televisions.

14. The display control system of claim 1, wherein the control device is configured to communicate with each of the plurality of TV sensors simultaneously.

15. The display control system of claim 1, wherein the control device is configured to communicate a single control signal to each of the plurality of TV sensors for controlling each of the plurality of televisions.

16. The display control system of claim 1, wherein the control device is configured to communicate with each of the plurality of TV sensors for powering off the plurality of televisions.

17. The display control system of claim 1, wherein the control device is not a remote control.

18-32. (canceled)

33. A method for controlling a plurality of televisions comprising:
operably engaging a plurality of TV sensors with a respective one of a plurality of televisions; and
inputting a command at a control device located remotely from the plurality of televisions and the plurality of TV sensors such that a control signal is transmitted to each of the plurality of TV sensors for controlling the televisions.

34. The method of claim 33, wherein operably engaging comprises operably engaging a respective HDMI input port of each of the plurality of televisions.

35. The method of claim 33, further comprising communicating a schedule from the control device to each of the plurality of TV sensors for automating the control of each of the TV sensors.

36. The method of claim 33, further comprising receiving a signal at the control device in response to removal of any one of the plurality of TV sensors from a respective television.

37. The method of claim 33, further comprising receiving information at the control device regarding each of the televisions from each of the plurality of TV sensors.

38. The method of claim 37, further comprising managing a planogram of the plurality of televisions at the control device based on the information.

39. The method of claim 33, further comprising sending one or more images from the control device to each of the plurality of TV sensors for display on the plurality of televisions.

40. The method of claim 33, wherein inputting comprising inputting a command for communicating with each of the plurality of TV sensors simultaneously.

41. The method of claim 33, wherein inputting comprises inputting a command for communicating a single control signal to each of the plurality of TV sensors for controlling each of the plurality of televisions.

42. The method of claim 33, wherein inputting comprises inputting a command to power off the plurality of televisions.

43. The method of claim 33, wherein inputting does not include inputting a command with a remote control.

44. (canceled)

45. (canceled)

46. The display control system of claim 1, wherein each of the plurality of TV sensors comprises a power source configured to be charged by the television.

47. The display control system of claim 1, wherein each of the plurality of TV sensors comprises a real-time clock for determining a time and a memory configured to store a schedule for controlling a respective television, and wherein the real-time clock is configured to determine when to control the television based on the schedule.

48. The display control system of claim 1, wherein each of the plurality of TV sensors comprises an input port configured to operably engage a media player for delivering media to the television.
